(19) United States
(12) Patent Application Publication
(10) Pub. No.: US 2026/0081753 A1
(43) Pub. Date: Mar. 19, 2026

(54) METHOD FOR PROCESSING HOMOMORPHIC ENCRYPTION AND ELECTRONIC APPARATUS

(71) Applicant: CRYPTO LAB INC., Seoul (KR)

(72) Inventors: Jaehyung Kim, Stanford, CA (US); Taeyeong Noh, Seoul (KR)

(21) Appl. No.: 19/290,899

(22) Filed: Aug. 5, 2025

(30) Foreign Application Priority Data
Aug. 5, 2024 (KR) 10-2024-0104201
Aug. 1, 2025 (KR) 10-2025-0105705

(51) Int. Cl. H04L 9/06; H04L 9/00

(52) U.S. Cl. CPC H04L 9/0618; H04L 9/008

(57) ABSTRACT

A ciphertext processing method of an electronic apparatus is disclosed. The method includes storing a plurality of first homomorphic ciphertexts homomorphically encrypted according to a first scheme, and transforming the plurality of stored first homomorphic ciphertexts into a second homomorphic ciphertext according to a second scheme. The transforming comprises generating one third homomorphic ciphertext corresponding to a first region of each of the plurality of first homomorphic ciphertexts, generating one fourth homomorphic ciphertext corresponding to a second region of each of the plurality of first homomorphic ciphertexts, and generating the second homomorphic ciphertext by using the third homomorphic ciphertext and the fourth homomorphic ciphertext, wherein the second region excludes the first region from the entire region.

### TECHNICAL FIELD

This disclosure relates to a method and apparatus for processing homomorphic ciphertext, in particular for high-precision transformation between different homomorphic encryption schemes.

### BACKGROUND ART

With an advancement in communication technologies and an expansion in the supply of electronic apparatuses, various efforts have been made to ensure security between electronic apparatuses. Accordingly, in most communication environments, encryption and decryption technologies are widely used.

Ordinarily, when a message encrypted by an encryption technology is delivered to a counterpart, the counterpart needs to perform decryption to use the message. However, this decryption may cause security problems such as leakage of information when a temporarily decrypted message is exposed to an attack such as hacking, as well as increased consumption of computational resources and time.

To solve such problems, research into homomorphic encryption methods has been conducted. Homomorphic encryption allows operations to be performed directly on encrypted data without decryption, and according to this method, the result of an operation performed on a ciphertext corresponds to the encryption of the result obtained by performing the same operation on the plaintext. Thus, operations can be performed on sensitive data safely without decryption.

There are various types of homomorphic encryption methods, each with unique features suited to specific operational environments. Accordingly, a homomorphic ciphertext often needs to be transformed in a manner optimized for its intended purpose during transmission, storage, or operation. In particular, there is a need for technology that maintains or enhances the precision of operations when changing from one homomorphic encryption scheme to another.

### DISCLOSURE OF INVENTION

### Solution to Problem

Embodiments of the present disclosure address at least one of the problems described above. The invention provides a homomorphic ciphertext processing method and electronic apparatus capable of efficiently transforming homomorphic ciphertext with improved precision for multiple encryption schemes.

Further, additional aspects may be clearly described as part of the following description, or clearly understood from the description or the embodiment set forth herein.

A ciphertext processing method according to one embodiment is disclosed. The method includes storing a plurality of first homomorphic ciphertexts encrypted according to a first scheme, and transforming the plurality of stored first homomorphic ciphertexts into a second homomorphic ciphertext according to a second scheme. The transforming comprises generating a third homomorphic ciphertext corresponding to a first region of each of the first homomorphic ciphertexts, generating a fourth homomorphic ciphertext corresponding to a second region of each of the first homomorphic ciphertexts, and generating the second homomorphic ciphertext by using the third and fourth homomorphic ciphertexts, wherein the second region excludes the first region from the entire region.

The transforming further comprises unpacking the third homomorphic ciphertext to generate a plurality of fifth homomorphic ciphertexts, and performing subtraction operations of the fifth homomorphic ciphertexts from each of the first homomorphic ciphertexts to generate sixth homomorphic ciphertexts corresponding to the second region. The generating one fourth homomorphic ciphertext may include viewing a plurality of sixth homomorphic ciphertexts corresponding to a remaining second region of each of the plurality of first homomorphic ciphertexts as a homomorphic ciphertext having a rank of k and a dimension of 1, and transforming the plurality of sixth homomorphic ciphertexts into a ninth homomorphic ciphertext having a plurality of dimensions, and generating the one fourth homomorphic ciphertext having a rank of 1 and a dimension of N by using the ninth homomorphic ciphertext.

The generation of the third homomorphic ciphertext may include rescaling the first homomorphic ciphertexts to obtain ciphertexts corresponding to a most significant bit region, treating the rescaled ciphertexts as a homomorphic ciphertext having a rank k and a dimension of 1, converting the rescaled ciphertexts into a seventh homomorphic ciphertext having multiple dimensions, generating an eighth homomorphic ciphertext having a rank of 1 and a dimension of N by using the seventh homomorphic ciphertext, and inverse-rescaling the eighth homomorphic ciphertext to generate the third homomorphic ciphertext.

The generation of the fourth homomorphic ciphertext may include transforming sixth homomorphic ciphertexts into a ninth homomorphic ciphertext having multiple dimensions by treating the sixth homomorphic ciphertexts corresponding to a remaining second region as a homomorphic ciphertext having a rank k and a dimension of 1, and generating the fourth homomorphic ciphertext having a rank of 1 and a dimension of N by using the ninth homomorphic ciphertext.

The transforming into the ninth homomorphic ciphertext may include transforming the sixth homomorphic ciphertexts into k tenth homomorphic ciphertexts each having a rank k and a dimension of N/k, and the transforming into the fourth homomorphic ciphertext may include merging the k tenth homomorphic ciphertexts into the one fourth homomorphic ciphertext.

The first region may correspond to a most significant bit (MSB) region of the homomorphic ciphertext, and the second region may correspond to a least significant bit (LSB) region excluding the MSB region from the entire region.

The method may further comprise receiving the plurality of first homomorphic ciphertexts and storing the second homomorphic ciphertext.

An electronic apparatus is provided, including a memory configured to store at least one instruction and a processor configured to execute the instruction to transform first homomorphic ciphertexts, encrypted according to a first scheme, into a second homomorphic ciphertext according to a second scheme. The processor is configured to generate a third homomorphic ciphertext corresponding to a first region of each of the first homomorphic ciphertexts, generate a fourth homomorphic ciphertext corresponding to a second region of each of the first homomorphic ciphertexts, and generate the second homomorphic ciphertext by using the third and fourth homomorphic ciphertexts, wherein the second region excludes the first region from the entire region.

The processor may be configured to unpack the third homomorphic ciphertext to generate fifth homomorphic ciphertexts, and perform subtraction operations of the fifth homomorphic ciphertexts from each of the first homomorphic ciphertexts to generate sixth homomorphic ciphertexts corresponding to the second region.

The processor may be configured to rescale the first homomorphic ciphertexts to obtain ciphertexts corresponding to a most significant bit region, treat the rescaled ciphertexts as a homomorphic ciphertext having a rank k and a dimension of 1, convert the rescaled ciphertexts into a seventh homomorphic ciphertext having multiple dimensions, generate an eighth homomorphic ciphertext having a rank of 1 and a dimension of N by using the seventh homomorphic ciphertext, and inverse-rescale the eighth homomorphic ciphertext to generate the third homomorphic ciphertext.

The processor may be configured to transform sixth homomorphic ciphertexts into a ninth homomorphic ciphertext having multiple dimensions by treating the sixth homomorphic ciphertexts corresponding to a remaining second region as a homomorphic ciphertext having a rank k and a dimension of 1, and generate the fourth homomorphic ciphertext having a rank of 1 and a dimension of N by using the ninth homomorphic ciphertext.

The processor may be configured to transform the sixth homomorphic ciphertexts into k tenth homomorphic ciphertexts each having a rank k and a dimension of N/k, and merge the k tenth homomorphic ciphertexts into the fourth homomorphic ciphertext.

The first region may correspond to a most significant bit region, and the second region may correspond to a least significant bit region excluding the most significant bit region from the entire region.

The apparatus may further include a communication device configured to communicate with an external device, wherein when the processor receives the first homomorphic ciphertexts through the communication device, the processor stores the second homomorphic ciphertext corresponding to the received ciphertexts in the memory.

A non-transitory computer-readable medium is provided, including a program that, when executed by a processor, performs a method of storing first homomorphic ciphertexts encrypted according to a first scheme, transforming the stored first homomorphic ciphertexts into a second homomorphic ciphertext according to a second scheme, and generating intermediate homomorphic ciphertexts corresponding to different regions, including generating a third homomorphic ciphertext corresponding to a first region, generating a fourth homomorphic ciphertext corresponding to a second region, and generating the second homomorphic ciphertext by using the third and fourth homomorphic ciphertexts, wherein the second region excludes the first region from the entire region.

### BRIEF DESCRIPTION OF DRAWINGS

Descriptions provided above, and various aspects, features and advantages of the embodiments set forth herein may be understood more clearly with reference to the following descriptions and accompanying drawings:

FIG. 1 is a view provided to explain a structure of a network system according to one embodiment;

FIG. 2 is a block diagram illustrating an example of a simple configuration of an electronic apparatus according to one embodiment;

FIG. 3 is a block diagram illustrating an example of a specific configuration of an electronic apparatus according to one embodiment;

FIG. 4 is a view illustrating processes of generating a homomorphic ciphertext and decrypting a homomorphic ciphertext according to one embodiment;

FIG. 5 is a view illustrating a process of rebooting (bootstrapping) according to one embodiment;

FIG. 6 is a view provided to explain an action of merging a homomorphic ciphertext according to one embodiment;

FIG. 7 is a view provided to explain an action of merging a homomorphic ciphertext according to one embodiment;

FIG. 8 is a flowchart provided to explain a control method of an electronic apparatus according to one embodiment; and

FIG. 9 is a flowchart provided to explain a method of merging a plurality of homomorphic ciphertexts into one according to one embodiment.

### MODE FOR INVENTION

For a comprehensive understanding of the embodiments of the disclosure defining the claims and equivalents thereof and the like, detailed description is provided with reference to the accompanying drawings. The embodiments set forth herein are described merely as examples for a better understanding of the subject matter of the disclosure. Accordingly, it is to be understood that various modifications and alterations made by those skilled in the art based on the particulars set forth herein are recognized as being included in the embodiments of the disclosure. Additionally, description of well-known functions and configurations may be avoided to secure conciseness and precision.

The meanings of the terms and words used in the Detailed Description or Claims are not limited to bibliographical meanings thereof, and the terms and words are merely used by the Inventor for an understanding of the subject matter of the disclosure. Accordingly, the following description of the embodiments of the disclosure is provided only as examples, and obviously is not intended to limit the definition of the accompanying claims and equivalents thereof.

In the disclosure, singular forms such as “a”, “an”, “the” include plural forms as well, unless clearly indicated otherwise. For example, “a component surface” needs to be interpreted as including one or more component surfaces.

Additionally, the embodiments described hereafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

The terms set forth herein are merely used to describe specific embodiments, and are not intended to limit the scope of the rights for which protection is sought. Unless explicitly stated otherwise, singular forms include plural forms as well.

In the disclosure, expressions such as “have,” “may have,” “include,” or “may include,” and the like are used to indicate the presence of a corresponding feature (e.g., a numerical value, a function, an action, or an element such as a component and the like), and do not imply exclusion of the presence of additional features.

In the disclosure, expressions such as “A or B,” “at least one of A or/and B,” or “one or more of A or/and B”, and the like may include all possible combinations of the items listed together. For example, “A or B,” “at least one of A and B,” or “at least one of A or B” may refer to all cases including (1) at least one A, (2) at least one B, or (3) both of at least one A and at least one B.

In the disclosure, expressions such as “1st”, “2nd”, “first”, or “second”, and the like may be used to refer to various elements regardless of their order and/or importance, and may be merely used to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

On the other hand, based on one element (e.g., a first element) referred to as being “directly coupled with/to or connected with/to” another element (e.g., a second element), it is to be understood that yet another element (e.g., a third element) is not present between one element and another element.

The expression “configured to (or set to) . . . ” used herein may be used interchangeably with, for example, “suitable for . . . ,” “having the capacity to . . . ,” “designed to . . . ,” “adapted to . . . ,” “made to . . . ,” or “capable of . . . ” depending on circumstances. The term “configured to (or set to) . . . ” may not necessarily mean “specifically designed to . . . ” in a hardware manner.

Instead, in a certain situation, the expression “a device configured to . . . ” may mean “capable of performing . . . ” by the device together with another device or other components. For example, the phrase “a processor configured (or set) to perform A, B and C” may mean an exclusive processor (e.g., an embedded processor) for performing corresponding functions, or a generic-purpose processor (e.g., a CPU or an application processor) capable of performing corresponding functions by executing one or more software programs stored in a memory device.

In the embodiments, the term “module” or “unit” may perform at least one function or action, and be implemented by hardware or software or by a combination of hardware and software. Additionally, multiple “modules” or multiple “units” may be integrated into at least one module and be implemented as at least one processor except for a “module” or a “unit” that needs to be implemented by specific hardware.

Additionally, the term “value” in the disclosure is defined as a concept including a vector as well as a scalar value. Further, expressions such as “produce,” “calculate,” and the like in the disclosure may be replaced with the term generation of a result of the production or computation. Further, unless stated otherwise, an operation of a ciphertext described hereafter means a homomorphic operation. For example, addition of a homomorphic ciphertext means homomorphic addition of two homomorphic ciphertexts.

An arithmetic operation and production in each step described hereafter according to the disclosure may be implemented as a computer operation based on a coding method well-known for the operation or production and/or coding devised to be suitable for the disclosure.

Detailed formulas described hereafter are provided as examples among possible alternatives, and the scope of the right to the subject matter according to the disclosure shall not be interpreted as being limited to the formulas set forth herein.

Actions performed by a module, a program, or another element, according to the embodiments, may be executed sequentially, in parallel, repetitively, or empirically (heuristically), or at least part of the actions may be executed in a different order, may be omitted, or may add another action.

Various elements and areas in the drawings are schematically illustrated. Accordingly, the technical spirit of the disclosure is not limited by relative sizes or distances illustrated in the accompanying drawings.

Hereafter, the embodiments of the disclosure are described in detail with reference to the drawings such that those skilled in the art to which the subject matter of the disclosure pertains may implement the embodiments readily.

Blocks in each of the flowcharts and combinations of the flowcharts may be performed by one or more computer programs including instructions. The one or more computer programs may be entirely stored in a single memory device, or may be segmented and stored in a plurality of different memory devices.

Any functions and actions set forth herein may be processed by one processor or a combination of processors. The one processor or the combination of processors may include circuitry, an application processor (e.g., a central processing unit (CPU), a communication processor (e.g., a modem), a graphics processing unit (GPU), a neural processing unit (NPU; e.g., an AI chip), Wi-Fi, a chip, a Bluetooth chip, a GPS chip, a NFC chip, a connectivity chip, a sensor controller, a touch controller, a fingerprint sensor controller, display drive integration circuitry, an audio CODEC chip, a universal serial bus (USB) controller, a camera controller, an image processing IC, a microprocessor unit (MPU), a System on a Chip (SoC), an integrated circuit (IC) and the like) that perform processing.

Notations set forth herein are described as follows.
a←D: Select an element a depending on distribution D.
s₁, s₂∈R: S₁, S₂ are respectively elements that belong to R set.
mod(q): Perform a modular operation with element q.
└⋅┐: Round an inner value.

Hereafter, the embodiments according to the disclosure are described in detail with reference to the accompanying drawings.

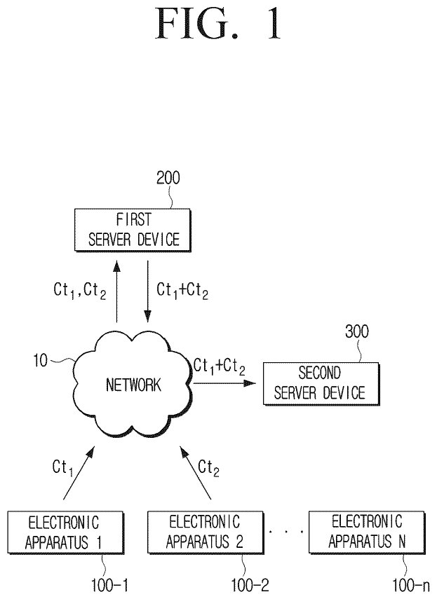

FIG. 1 is a view provided to explain a structure of a network system according to one embodiment.

Referring to FIG. 1, the network system may include a plurality of electronic apparatuses 100-1 to 100-n, a first server 200, and a second server 300, and each of the elements may be communicably connected through a network 10.

The network 10 may be implemented as various types of wired/wireless communication networks, broadcast and telecommunication networks, optical communication networks, cloud networks and the like, and each apparatus may also be connected based on methods such as Wi-Fi, Bluetooth, Near Field Communication (NFC) and the like, without a separate medium.

A plurality of electronic apparatuses is illustrated in FIG. 1, but the plurality of electronic apparatuses is not necessarily used, and instead, one electronic apparatus may be used. As one example, the electronic apparatuses 100-1 to 100-n may be implemented as various types of apparatuses such as a smartphone, a tablet, a game console, a PC, a laptop PC, a home server, a kiosk and the like, and may also be implemented in the form of a home application to which an IoT function is applied.

The user may input various types of information through the electronic apparatuses 100-1 to 100-n that are used by the user. The input information may be stored in the electronic apparatuses 100-1 to 100-n themselves, but may also be transmitted to and stored in an external device for reasons of a limitation of storage capacity and security. In FIG. 1, the first server 200 may play a role in storing such information, while the second sever 300 may play a role in using all of part of the information stored in the first server 200.

Each of the electronic apparatuses 100-1 to 100-n may homomorphically encrypt the input information, and transmit a homomorphic ciphertext to the first server 200. At this time, the homomorphic ciphertext may be a first-form homomorphic ciphertext (e.g., LWE), or may be a second-form homomorphic ciphertext (RLWE).

Each of the electronic apparatuses 100-1 to 100-n may include, in a homomorphic ciphertext, an encrypted noise, i.e., an error, produced during a process in which homomorphic encryption is performed. For example, a homomorphic ciphertext generated in each of the electronic apparatuses 100-1 to 100-n may be generated in the way that when the homomorphic ciphertext is decrypted by using a secret key later, a resultant value including a message and an error value is restored.

As one example, a homomorphic ciphertext generated in the electronic apparatuses 100-1 to 100-n may be generated in the way that the homomorphic ciphertext is characterized as follows, when the homomorphic ciphertext is decrypted by using a secret key.

$$Dec ( ct , sk ) = < ct , sk > = M + e ( mod q ) \qquad [ Formula 1 ]$$

Herein, <, > denotes an inner operation (a usual inner product), ct denotes a ciphertext, sk denotes a secret key, M denotes a plaintext message, e denotes an encryption error value, mod q denotes a modular operation in a ciphertext, and q is a modulus.

Herein, q needs to be selected such that q may be greater than a resultant value M calculated by multiplying a scaling factor Δ by a message. In the case where an absolute value of error value e is sufficiently less than M, a decryption value M+e of a ciphertext is a value where an original message is replaceable with identical precision in a significant figure operation. Among decrypted data, an error may be disposed toward a least significant bit (LSB), while M may be disposed toward a second least significant bit.

In the case where the size of a message is too small or too big, the size may be adjusted by using a scaling factor. If the scaling factor is used, a real number-type message may be encrypted as well as an integer-type message, securing significant improvement in availability. Additionally, the scaling factor is used to adjust the size of the message, such that the size of an area where messages are present, i.e., an effective area, in the ciphertext after performance of an operation, is adjusted.

According to an embodiment, ciphertext modulus q may be set in various ways for use. As one example, the ciphertext modulus may be set in the form of q=Δ^{L} (scaling factor Δ to the power of L). In the case of Δ of 2, the ciphertext modulus may be set to a value such as q=2¹⁰.

A homomorphic ciphertext generated in an electronic apparatus 100 according to the disclosure may be a LWE-method ciphertext. Herein, the LWE-method ciphertext is used to reduce a communication resource in the process of transmitting a ciphertext. However, when implemented, a Module Learning with Errors (MLWE) method or a Ring Learning with Errors (RLWE) method may also be used rather than a Learning with Errors (LWE) method. Additionally, a homomorphic ciphertext generated in the disclosure may be based on a method by which a partial ingredient (information) constituting the ciphertext is only generated, rather than ordinary LWE, RLWE methods.

The above-described LWE method, as a method of homomorphically encrypting a single message, may be referred to as single-message homomorphic encryption and the like. The RLWE method, as a homomorphic encryption method by which a plurality of slots is provided and a message is included in each slot, may be referred to as multiple-message homomorphic encryption, CKKS homomorphic encryption and the like. The MLWE method is a homomorphic encryption method by which the above-described LWE and RLWE methods are generalized. In this context, the LWE method may be deemed as a MLWE method of which a rank is k and a dimension is 1. In other words, a method of LWE^{k}=MLWE^{k}₁. RLWE may be deemed as a MLWE method of which a rank is 1 and a dimension is N. In other words, RLWE_{N}=MLWE¹_{N}.

Hereafter, for convenience of description, a first scheme (LWE)-method homomorphic ciphertext is referred to as a first homomorphic ciphertext (or a LWE ciphertext), a second scheme (RLWE)-method homomorphic ciphertext is referred to as a second homomorphic ciphertext (or a RLWE ciphertext), and a third scheme (MLWE)-method homomorphic ciphertext is referred to as an intermediate homomorphic ciphertext (or a MLWE ciphertext).

As described above, the MLWE ciphertext may be deemed as a ciphertext in which encryption methods such as the LWE, RLWE and the like are generalized, and may be used as an intermediate medium to proceed with a transformation between a LWE ciphertext and a RLWE ciphertext. The transformation action and the above merge action are described in detail hereafter.

Considering that the above-described transformation process is performed based on a homomorphic operation, an error may be added in the transformation process. To ensure a transformation result with high precision or a low error, a large dimension, or a large modules needs to be used.

To secure high precision of an operation of the same sort as CKKS, a high modulus in proportion to the high precision needs to be used. However, the security of homomorphic encryption tends to be decreased as the modulus is increased. Considering this, security with respect to a fixed ring dimension is decreased as the modulus is increased, and accordingly, a maximum modulus that is available while maintaining security with respect to the fixed ring dimension is present.

However, as described above, security must be affected by a change in the modulus to enhance precision. In this context, a method for maintaining precision of an operation at a time of transformation between ciphertext methods is required.

In the disclosure, to satisfy the requirement, a transformation algorithm is suggested for enhancing precision only, based on a phased transformation, without transforming a modulus and a ring dimension.

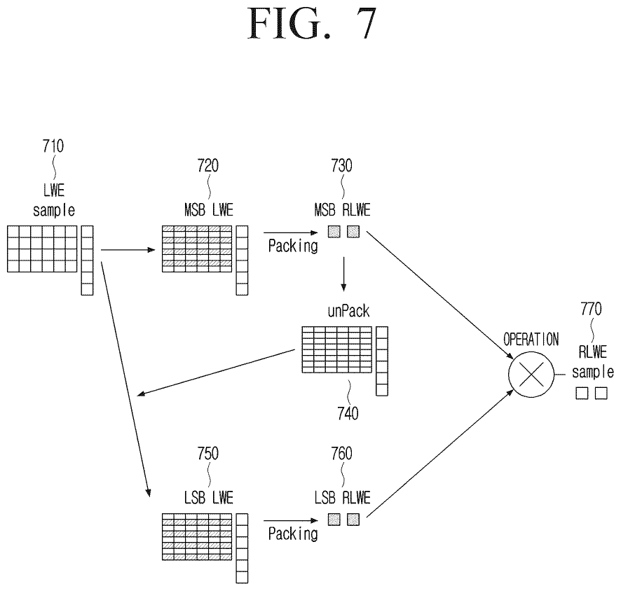

For example, the above-described transformation (or merge) is applied first to a first region (i.e., a most significant bit region) only among a plurality of first homomorphic ciphertexts, and then applied to the remaining area (i.e., a least significant bit (LSB) region), and a difference between the two areas is added finally to perform a transformation. A specific action is described in detail with reference to FIG. 7.

The first server 200 may store a received homomorphic ciphertext in a ciphertext state, without decrypting the received homomorphic ciphertext. The first server 200 may store a homomorphic ciphertext encrypted based on various methods as well as a homomorphic ciphertext encrypted based on one scheme method.

In this case, the first server 200 may perform a transformation action on homomorphic ciphertexts encrypted based on a different scheme, or perform processing of merging the plurality of homomorphic ciphertexts into one.

The second server 300 may request a specific processing result of a homomorphic ciphertext from the first server 200. The first server 200 may perform a specific operation at the request of the second server 300 and then transmit a result of the operation to the second server 300.

As one example, in the case where ciphertexts ct1, ct2 transmitted by two electronic apparatuses 100-1, 100-2 are stored in the first server 200, the second server 300 may request, from the first server 200, a value where pieces of information provided from the two electronic apparatuses 100-1, 100-2 are added. In response to the request, the first server 200 may perform an operation of adding the two ciphertexts, and then transmit a resultant value ct1+ct2 of the operation to the second server 300.

Above, each ciphertext having one message is described, but when implemented, each ciphertext may include a plurality of messages. In other words, the ciphertext may be a RLWE-form ciphertext described above. Accordingly, a homomorphic operation with respect to the RLWE-form ciphertext may be dealt with as a matrix operation.

Considering the attributes of a homomorphic ciphertext, the first server 200 may perform an operation in a non-decrypted state, and a resultant value of the operation may be formed into a ciphertext. In the disclosure, a resultant value obtained based on an operation is referred to as an operation-resulting ciphertext.

The first server 200 may transmit the operation-resulting ciphertext to the second server 300. The second server 300 may decrypt the received operation-resulting ciphertext, to obtain operation result values of data included in homomorphic ciphertexts respectively.

The first server 200 may perform an operation a few times at the request of the user. In this case, an approximate message proportion in an operation-resulting ciphertext obtained each time an operation is performed varies. In the case where the approximate message proportion exceeds a threshold value, the first server 200 may perform a rebooting (bootstrapping) action. Considering that the first server 200 performs an operation action as described above, the first server 200 may also be referred to as an operation device.

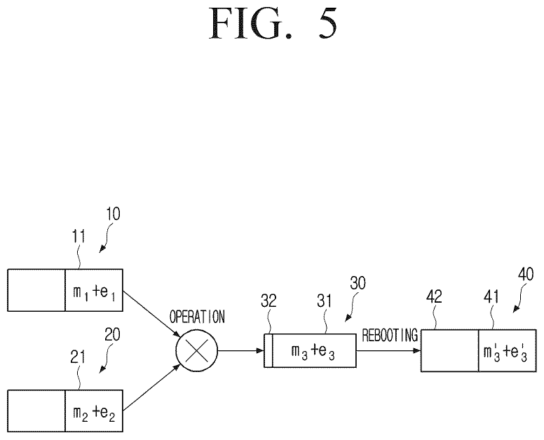

In the case where in Formula 1 described above, q is less than M, M+e (mod q) has a value different from M+e, and accordingly, decryption is disabled. To prevent this from happening, value q needs to be greater than M all the time. However, as an operation proceeds, value q is decreased gradually. Accordingly, an action of changing value q to a value greater than M all the time is required, and the action is referred to as a rebooting action. As the rebooting action is performed, the ciphertext may be brought again into a state where an operation can be performed on the ciphertext. A specific action associated with rebooting is described hereafter with reference to FIG. 5.

In FIG. 1, a first electronic apparatus and a second electronic apparatus perform encryption and the second server performs decryption, but are not necessarily limited thereto.

The network system according to the disclosure may use a first-form homomorphic ciphertext at a time of transmission of a homomorphic ciphertext, while using a second-form homomorphic ciphertext at a time of storage of a homomorphic ciphertext, and accordingly, the network system may reduce a communication resource further at a time of transmission of a homomorphic ciphertext. Additionally, the network system may use a homomorphic ciphertext advantageous at a time of storage of data, securing storage efficiency.

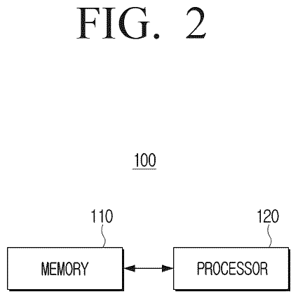

FIG. 2 is a block diagram illustrating an example of a simple configuration of an electronic apparatus according to one embodiment.

Referring to FIG. 2, an electronic apparatus 100 may be comprised of memory 110 and a processor 120. The electronic apparatus may be implemented as various types of apparatuses such as a smartphone, a tablet, a game console, a PC, a laptop PC, a server, an IoT device and the like. When implemented, the electronic apparatus 100 may perform the function of the first server 200 or the second server 300 as well as the function of the electronic apparatus in FIG. 1.

The memory 110 is an element storing an operating system O/S for driving the electronic apparatus 100, various instructions, software and data associated with the generation and operation processing of a homomorphic ciphertext described hereafter.

The memory 110 may be implemented in various forms such as RAM or ROM, flash memory, HDD, external memory, a memory card, and the like, and not limited to any one of them.

The memory 110 stores a message to be encrypted. Herein, the message may be various types of credit data, personal information and the like used by the user, and may be position information, information associated with usage history such as information on time spent on the Internet and the like used by the electronic apparatus 100.

The memory 110 may store a public key, and in the case where the electronic apparatus 100 is an apparatus generating a public key directly, may store various types of parameters required to generate a public key and a secret key as well as a secret key.

The memory 110 may store a homomorphic ciphertext (e.g., a merged homomorphic ciphertext or a homomorphic ciphertext that is a result of a homomorphic operation and the like) generated in a process described hereafter. At this time, the ciphertext stored in the memory 110 may be a RLWE-based ciphertext.

The processor 120 controls each of the elements in the electronic apparatus 100. The processor 120 may be comprised of a single device such as a central processing unit (CPU), an application-specific integrated circuit (ASIC), and may also be comprised of a plurality of devices such as a CPU, a graphics processing unit (GPU) and the like.

In the case where a message to be transmitted is input, the processor 120 stores the message in the memory 110. The processor 120 may homomorphically encrypt the message, by using various set values and programs stored in the memory 110. In this case, a public key may be used.

The processor 120 itself may generate a public key required to perform encryption for use, and may receive a public key for use from an external device. As one example, the second server 300 performing decryption may generate a public key and distribute the public key to other apparatuses.

In the case where the electronic apparatus 100 generates a key directly, the processor 120 may generate a public key based on a Ring-LWE method. More specifically, the processor 120 may set various types of parameters and rings first, and store the same in the memory 110. The parameters may include a length of a plaintext message bit, dimension k, rank k, a public key and a secret key and the like, for example. The homomorphic encryption has different forms, and the processor 120 may set a ring based on a ciphertext method according to a user-set method or a predetermined method. For example, the above-described homomorphic ciphertext method may be based on a CKKS scheme, a RLWE scheme and the like.

The ring may be represented by Formula 2 hereafter.

$$R = {Z}_{q} [ X ] / f ( x ) \qquad [ Formula 2 ]$$

Herein, R denotes a ring, Zq denotes a coefficient, and f(x) is a nth degree polynomial.

The ring is a set of polynomials having a predetermined coefficient, and in the ring, addition and multiplication are defined among elements, and the ring means a set closed based on addition and multiplication. The ring may be referred to as a loop.

As one example, the ring means a set of nth degree polynomials of which a coefficient is Zq. For example, in the case where n is Φ(N), the ring means polynomials that can be produced as a remainder left by dividing polynomials by a Nth cyclotomic polynomial. Herein, (f(x)) denotes an ideal of Zq[x] generated by f(x). Euler totient function Φ(N) denotes the number of natural numbers that are coprime numbers of N and less than N.

The ring used for the above-described MLWE may be represented as Formula 3 hereafter.

$${R}_{q , N} = {Z}_{q} [ {X}_{( N )} ] / ( {X}_{( N )}^{N} + 1 ) \qquad [ Formula 3 ]$$

Herein, q is a modulus, k is a rank, and N is a dimension. The above ring is assumed to be MLWE, and in the case where LWE is used, N is replaced with 1 for use, and in the RLWE method, k is replaced with 1 for use.

As the above-described ring is set, the processor 120 may produce a secret key sk from the ring.

$$s k ← ( 1 , s ( x ) ) , s ( x ) ∈ R \qquad [ Formula 4 ]$$

Herein, s(x) denotes a polynomial generated randomly with a small coefficient.

As the ring and secret key are selected, the processor 120 produces a first random polynomial a(x) from the ring. The first random polynomial may be expressed as follows.

$$a ( x ) ← R \qquad [ Formula 5 ]$$

The processor 120 may produce an error. For example, the processor 120 may extract an error from a discrete Gaussian distribution or a distribution at a close statistical distance from the discrete Gaussian distribution. The error may be expressed as follows.

$$e ( x ) ← {D}_{α q}^{n} \qquad [ Formula 6 ]$$

As the error is produced, the processor 120 may modular-operate the error to the first random polynomial and the secret key to produce a second random polynomial.

The second random polynomial may be expressed as follows.

$$b ( x ) = - a ( x ) s ( x ) + e ( x ) ( mod q ) \qquad [ Formula 7 ]$$

Finally, the public key pk is set as follows in the way that the public key pk includes a first random polynomial and a second random polynomial.

$$p k = ( b ( x ) , a ( x ) ) \qquad [ Formula 8 ]$$

The particulars of Formulas 4-8 described above are described as an example using a CKKS scheme method (i.e., a RLWE method). When implemented, the LWE or MLWE method may be used, and in this case, the above-described actions may be modified and used in response to a corresponding method. Additionally, the public key and secret key may certainly be generated by using another method in addition to the above-described methods.

The processor 120 may generate a homomorphic ciphertext of a message. For example, the processor 120 may apply the public key generated previously with respect to the message to generate a homomorphic ciphertext. At this time, the generated homomorphic ciphertext may be a LWE-method ciphertext, but not limited thereto.

The processor 120 may generate the ciphertext such that the length of the ciphertext may correspond to the size of a scaling factor. Additionally, the processor 120 may generate only elements comprised of partial components of an ordinary LWE or RLWE-method ciphertext form as a ciphertext, rather than the LWE or RLWE-method homomorphic ciphertext form.

As the homomorphic ciphertext is generated, the processor 120 may store the homomorphic ciphertext in the memory 110, or control a communication device 410 to transmit the homomorphic ciphertext to another device based on a user request or a predetermined default instruction.

The processor 120 may transform the homomorphic ciphertext. For example, in the case where homomorphic ciphertexts exist in various forms, since the homomorphic ciphertexts have different dimensions or different ranks, an operation may not be performed on the homomorphic ciphertexts together.

In this case, to cover all dimensions and all ranks, the processor 120 may transform an input homomorphic ciphertext or a homomorphic ciphertext to be operation-processed to an N-dimension RLWE, a K-rank RLWE or an N-dimension K-rank RLWE, and perform operation processing using the transformed ciphertext.

The processor 120 may merge a plurality of homomorphic ciphertexts. At this time, the processor 120 may merge the homomorphic ciphertexts in various ways, and in the case where the ciphertexts are based on a RLWE method, the processor may merge the plurality of homomorphic ciphertexts based on a packing method. Meanwhile, merging a plurality of homomorphic ciphertexts into one ciphertext is described above, but when implemented, the processor 120 may also perform the above-described method on one homomorphic ciphertext. This case may be referred to as a form transformation, or compression action or the like of homomorphic ciphertexts described above.

If a plurality of (first) homomorphic ciphertexts is a LWE ciphertext, the processor 120 identifies that a (the) plurality of first homomorphic ciphertexts is a homomorphic ciphertext having a rank of k and a dimension of 1, transform the first homomorphic ciphertexts to a third homomorphic ciphertext with a plurality of dimensions, transform the third homomorphic ciphertext to a second homomorphic ciphertext having a rank of 1 and a dimension of N to perform a merge action.

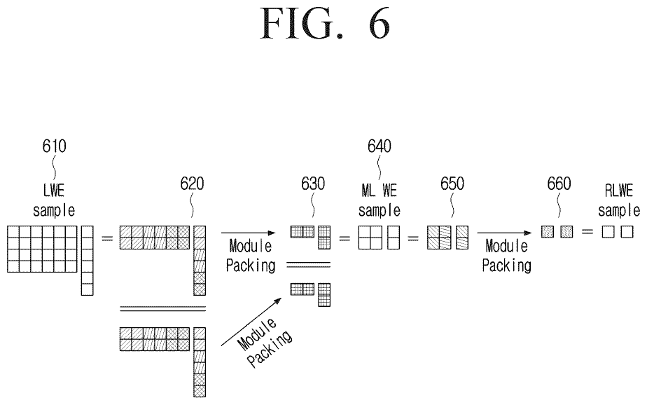

The above-described transformation process may be based on two methods, and one method is to use an intermediate ciphertext (MLWE), while the other is to perform a merge into a RLWE ciphertext having a low dimension through ring packing and ring switching and then perform a merge into a RLWE ciphertext having a high dimension. Herein, the ring packing is a technology for merging a plurality of ciphertexts into one high-dimension ciphertext. Such a transformation action is described in detail with reference to FIG. 6.

In the process of merging a plurality of homomorphic ciphertexts, the processor 120 may divide encryption areas of the plurality of homomorphic ciphertexts, and proceed with encryption for each of the divided areas. For example, the processor 120 may first merge (or transform) a most significant bit region only in the plurality of first homomorphic ciphertexts to generate one homomorphic ciphertext with respect to a most significant bit, and then merge (or transform) a least significant bit (LSB) region only in the plurality of first homomorphic ciphertexts to generate one homomorphic ciphertext with respect to a least significant bit.

Additionally, the processor 120 may also generate a final second homomorphic ciphertext by using the two homomorphic ciphertexts. The above-described transformation action securing enhanced precision is described hereafter with reference to FIG. 7.

The processor 120 may store the finally generated homomorphic ciphertext in the memory 110. Since the plurality of homomorphic ciphertexts is stored as one homomorphic ciphertext for use, as described, ensuring an advantage in management and storage capacity. Additionally, the processor 120 divides the most significant bit region and the least significant bit (LSB) area and process the same in the transformation process, such that the finally generated homomorphic ciphertext ensures precision twice greater than conventional.

Further, the above-described merge action may also be used to reduce a transmission amount not only in the case where a plurality of ciphertexts is stored but also the case where a plurality of homomorphic ciphertexts is transmitted to the outside.

As an operation is completed, the processor 120 may detect data of an effective area from operation result data. For example, the processor 120 may perform round-processing of the operation result data to detect data of an effective area. The round processing may denote rounding off a message in an encrypted state, and may also be referred to as rescaling.

For example, the processor 120 may multiply the ingredient of each ciphertext by a reverse Δ⁻¹ of a scaling factor and round off the multiplied ingredient, to remove a noise area. The noise area may be determined to correspond to the size of the scaling factor. As a result, a message of an effective area where the noise area is removed may be detected. Since the round processing proceeds in the encrypted state, an additional error may occur, but the size of the scaling factor is small enough to be ignored.

As a homomorphic operation with respect to a merged homomorphic ciphertext is input, the processor 120 may perform an action of recombining the merged homomorphic ciphertext. For example, the processor 120 may divide the merged homomorphic ciphertext into a plurality of first homomorphic ciphertexts, and merge only ciphertexts used for the homomorphic operation into a second homomorphic ciphertext (i.e., a RLWE ciphertext) among the divided first homomorphic ciphertexts. At this time, the processor 120 may generate the second homomorphic ciphertext such that a ModUp action in the operation process may be minimized.

As an instruction for transmitting a specific ciphertext in the merged homomorphic ciphertext is input, the processor 120 may also divide the merged homomorphic ciphertext into first homomorphic ciphertexts (i.e., LWE ciphertexts), and transmit a first homomorphic ciphertext corresponding to the transmission instruction to a corresponding apparatus among the divided ciphertexts.

For example, in the case where a message is comprised of a plurality of message vectors, the processor 120 may transform the plurality of message vectors to a polynomial of a form in which the plurality of message vectors can be encrypted in parallel, and then multiply the polynomial by a scaling factor and homomorphically encrypt the plurality of message vectors by using a public key. Accordingly, the processor may generate a ciphertext where the plurality of message vectors is packed.

The processor 120 may perform key-switching of a homomorphic ciphertext. Herein, the key switching is assumed in the case of a RLWE ciphertext, and the RLWE key switching is comprised of sub phases such as ModUp, ModDown, MultSwk. Such key switching is based on using gadget decomposition and a median integer.
ModUp: Embed a polynomial input belonging to R_{q,N} in R_{N} as/with R_{q,N}→R_{qp,N}.
MultSwk: Receive an input of a polynomial and a switching key, and perform multiplication for each dimension number of N, as/with

$${R}_{qp , N} \times {R}_{qp , N}^{2} \to {R}_{qp , N}^{2} .$$

ModDown: Receive an input of a ciphertext, and produce an approximate value of p, as/with

$${R}_{qp , N}^{2} \to {R}_{q , N}^{2} .$$

In the case where description of a homomorphic ciphertext is required, the processor 120 may apply a secret key to the homomorphic ciphertext to generate a decrypted text in the form of a polynomial, and decode the decrypted text in the form of a polynomial and restore the same as a message. At this time, the message may include an error additionally to an initial message as described above with reference to Formula 1.

The processor 120 may perform a homomorphic operation (or four basic operations) of a homomorphic ciphertext. For example, the processor 120 may perform an operation such as addition or multiplication or the like of the homomorphic ciphertext in the state where the homomorphic ciphertext remains encrypted. For example, the processor 120 may perform processing of a first function processing with respect to each homomorphic ciphertext to be used for an operation, perform an operation such as addition or multiplication or the like between the first function-processed homomorphic ciphertexts, and perform processing of a second function as a reverse function of a first function with respect to the homomorphic ciphertext in which the operation is performed. For the first function-processing and the second function-processing, a linear transformation technology in a rebooting process described hereafter may be used.

In the case where an approximate message proportion in an operation-resulting ciphertext exceeds a threshold value, the processor 120 may perform an action of rebooting the ciphertext. For example, the processor 120 may expand a modulus of the operation-resulting ciphertext, first linear-transform a homomorphic ciphertext where the modulus is expanded in the form of a polynomial, perform an approximate operation of a first homomorphic ciphertext transformed in the form of a polynomial by using a function set to approximate a modulated range of a plaintext, second linear-transform an approximately operated second homomorphic ciphertext in the form of a homomorphic ciphertext, and subtract a second-linear transformed second homomorphic ciphertext from the homomorphic ciphertext where the modulus is expanded, to generate a homomorphic ciphertext where a plaintext space is expanded.

As described above, the electronic apparatus 100 according to one embodiment may merge and store a plurality of homomorphic ciphertexts, maximizing storage efficiency, and in the case of transmission, may transform and transmit the homomorphic ciphertexts in the way that a transmission resource is reduced, enhancing transmission efficiency. Additionally, in the case where a homomorphic operation is required, the electronic apparatus 100 may perform an action of recombining a homomorphic ciphertext to enhance operation efficiency during the homomorphic operation process.

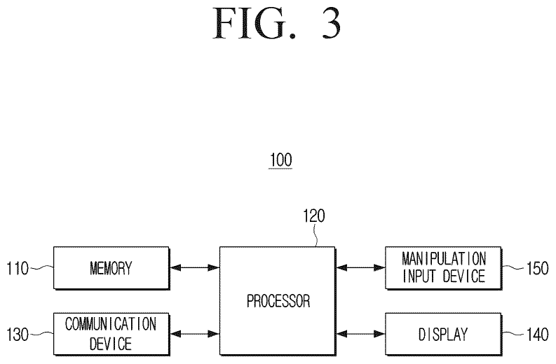

A simple configuration constituting the electronic apparatus 100 is only described above, but when implemented, various configurations may be provided additionally. Description in relation to this is provided with reference to FIG. 3.

FIG. 3 is a block diagram illustrating an example of a specific configuration of an electronic apparatus according to one embodiment.

Referring to FIG. 3, an electronic apparatus 100 of the disclosure may be comprised of memory 110, a processor 120, a communication device 130, a display 140 and a manipulation input device 150.

Basic configurations and functions of the memory 110 and the processor 120 are the same as those described with reference to FIG. 2, and additional functions are mainly described with reference to the drawing.

The communication device 130 is formed to connect the electronic apparatus 100 with an external device (not illustrated), and the connection between the electronic apparatus 100 and the external device may be based on a wired communication method (e.g., Universal Serial Bus (USB) and the like) or a wireless communication method (e.g., Wi-Fi 802.11a/b/g/n, NFC, Bluetooth) as well as a Local Area Network (LAN) and an Internet network. The communication device 130 may also be referred to as a transceiver.

The communication device 130 may receive a public key from an external device, and transmit, to an external device, a public key generated in the electronic apparatus 100.

The communication device 130 may receive a message from an external device, and transmit a generated homomorphic ciphertext to an external device. At this time, the homomorphic ciphertext received and transmitted may be a LWE-method homomorphic ciphertext, but not limited thereto.

The communication device 130 may receive various types of parameters required to generate a ciphertext from an external device. When implemented, various types of parameters may be input directly from the user through the manipulation input device 150 described hereafter.

The display 140 displays a user interface window for receiving a selection of a function supported by the electronic apparatus 100. For example, the display 140 may display a user interface window for receiving a selection of various functions provided by the electronic apparatus 100. The display 140 may be a monitor such as a LCD, a CRT, an OLED and the like, and may also be implemented as a touch screen capable of simultaneously performing the function of the manipulation input device 150 described hereafter.

The display 140 may display a message requesting an input of a parameter required to generate a secret key and a public key. Additionally, the display 140 may display a message in which an encryption target selects a message (a message selecting a message as an encryption target. When implemented, the encryption target may be selected directly by the user, or selected automatically. For example, personal information in need of encryption may be set as an encryption target automatically by a system without a user input.

The manipulation input device 150 may receive a selection of a function of the electronic apparatus 100 and an input of a control instruction with respect to the function from the user. For example, the manipulation input device 150 may receive an input of a parameter required to generate a secret key and a public key from the user. Additionally, the manipulation input device 150 may receive settings of a message to be encrypted from the user.

The manipulation input device 150 may receive a selection of homomorphic ciphertexts (or plaintexts) that need to be used together among a plurality of homomorphic ciphertexts. Based on the above-described selection instruction, the processor 120 may merge the plurality of homomorphic ciphertexts into one homomorphic ciphertext.

The manipulation input device 150 may receive an input of a transmission instruction, a homomorphic operation instruction and the like with respect to homomorphic ciphertexts. Additionally, the manipulation input device 150 may receive a selection of a merge method (or a transformation method). In other words, the manipulation input device 150 may receive a selection as to whether to perform a method of merging a plurality of homomorphic ciphertexts based on one action as illustrated in FIG. 6, or whether to perform a method of a merge based on a phased operation to enhance precision as illustrated in FIG. 7.

When receiving an input of a parameter required to generate a secret key and a public key from the user, the processor 120 may generate a setting parameter based on the input parameter, and generate a secret key and a public key based on the generated setting parameter.

In the case where generation of a ciphertext of a message is required, the processor 120 may apply a public key to the message to generate a homomorphic ciphertext. For example, the processor 120 may transform the message into a polynomial form, and apply the public key to the transformed polynomial-form message to generate a homomorphic ciphertext.

According to a selection instruction of the user, the processor 120 may perform processing of merging a plurality of homomorphic ciphertexts into one. At this time, the user may select a merge method, or set a merge method, and the processor 120 may perform a merge based on the method corresponding to the selection (or settings) of the user.

Additionally, in the case where an operation of the homomorphic ciphertexts is required, the processor 120 may perform an addition or multiplication operation of the plurality of homomorphic ciphertexts, requested by the user.

The electronic apparatus 100 according to the embodiment may generate and operate a homomorphic ciphertext with respect to a message, ensuring improvement in data reliability and security.

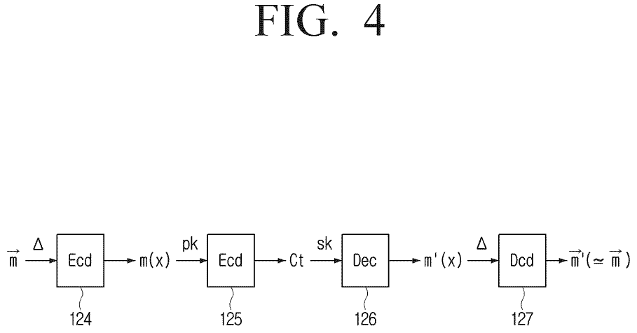

FIG. 4 is a view illustrating processes of generating a homomorphic ciphertext and decrypting a homomorphic ciphertext according to one embodiment.

Referring to FIG. 4, an encoding module 124 may receive an input of a message and a scaling factor, scale the message and then transform the message into a polynomial form.

For example, when receiving an input of a polynomial-form message and a scaling factor of 1 or greater, the encoding module 124 may output the message as a polynomial as shown hereafter in Formula 9.

$${m ( X ) = {Y}^{- 1} ( ⌊ Δ \cdot \vec{m} ⌉}_{Y ( {R}^{′} )} ∈ {R}^{′} \qquad [ Formula 9 ]$$

Herein, m(x) denotes a message transformed into a polynomial form, and R denotes a modulus ring. The transformation may be deemed as a linear transformation where a real number or an integer value is transformed into a polynomial coefficient.

An encryption module 125 may receive a polynomial-form message, and apply a public key to the received message to generate a homomorphic ciphertext. For example, the encryption module 125 may apply a public key to an encoded message, and add a selected error value to generate a ciphertext. A specific encryption method may be defined as shown in Formula 10.

$$v \cdot p k + ( m + {e}_{0} , {e}_{1} ) ( mod {q}_{L} ) \qquad [ Formula 10 ]$$

Herein, ν is a selected element, e₀, e1 is a selected error value, and q_{L} is a modulus.

Depending on embodiments, a ciphertext of a simplified structure may also be used as shown in Formula 11, rather than the entire ciphertext structure of Formula 10.

$$b = - 〈 \vec{a} , \vec{s} 〉 + m + e ( - {a}_{0} {s}_{0} + … + - {a}_{k - 1} {s}_{k - 1} ) + m + e \qquad [ Formula 11 ]$$

Herein, \vec{s}=(s₀, . . . , sₖ₋₁) is a secret key, m is a message, and e is an error.

While a decryption module 126 decrypts an initial message by using a ciphertext and a secret key, a decrypted message may include an a certain level of errors. For example, while the decryption module 126 may receive an input of a ciphertext and a secret key and decrypt the ciphertext to restore the initial message, the decryption module 126 may output the initial message in the way that the initial message includes a certain level of errors to improve security. The action of the decryption module 126 described above may be performed to correspond to a corresponding scheme in the same way as an encryption method.

Finally, a decoding module 127 may transform a decrypted polynomial message with respect to a scaling factor to restore a plaintext message finally. For example, since a message output from the decryption module 126 is a polynomial-form message, the decoding module 127 may restore an initial plaintext message finally by using a decrypted polynomial message and a scaling factor.

FIG. 5 is a view illustrating a process of rebooting (bootstrapping) according to one embodiment.

FIG. 5 shows processes of an operation and bootstrapping of two homomorphic ciphertexts 10, 20. In the disclosure, “rebooting” may means bootstrapping or a plaintext space expansion, and may be understood as a process of restoring an operation enabling space in a ciphertext.

Each homomorphic ciphertext 10, 20 may include an approximate message area 11, 21 respectively. A message and an error m₁+e₁, m₂+e₂ are included together in the approximate message area 11, 21.

The electronic apparatus 100 may perform a specific operation by using the two homomorphic ciphertexts 10, 20 as input values.

An operation-resulting ciphertext 30 may include an approximate message area 31 containing an operation result m₃+e₃ between each approximate message. An increase in the operation results leads to an increase in the size of the approximate message area 31, and accordingly, a remaining plaintext space 32 is decreased gradually.

As such an operation is repeated, the plaintext space 32 is used up or decreased below an allowable limitation, making it impossible to perform an additional operation. When determining such a state, the electronic apparatus 100 may perform a rebooting action.

In the case of a ciphertext 40 to which rebooting is applied, the approximate message area 41 is maintained, while the plaintext space 42 is expanded.

The above-described rebooting method may enable performance of continuous operation processing with respect to a homomorphic ciphertext since the plaintext space is expanded.

The above-described rebooting method enables an expansion of the plaintext space, and in the process, enables a change in modulus. Such a rebooting method may be applied at a time when a plurality of homomorphic ciphertexts is merged, and detailed description in relation to this is provided with reference to FIG. 7.

Hereafter, a method of transforming a traditional Learning with Errors (LWE)-method ciphertext into a Ring Learning with Errors (RLWE)-method ciphertext is described.

First, described are a background and necessity behind such a transformation.

A LWE ciphertext exhibits a low latency property, but has limitations since the LWE ciphertext stores only one message. On the contrary, a RLWE ciphertext ensures a high-speed operation in the state where the RLWE ciphertext stores a plurality of messages.

In this context, in the processes of storing and operation-processing data, the RLWE ciphertext is efficient, while in the process of transmitting data, the LWE ciphertext is efficient.

Accordingly, if the processes of transmission, operation-processing and storage of data can be performed with a ciphertext suitable for each of the processes based on a transformation function between two ciphertexts in a system transceiving a homomorphic ciphertext, the efficiency of the entire system may improve.

To this end, a transformation between a LWE ciphertext and a RLWE ciphertext needs to be enabled, and from a resource (e.g., time, an operation amount) perspective, the transformation needs to secure efficiency further than when a LWE ciphertext and a RLWE ciphertext are directly used without being transformed.

In this context, the efficiency of actions according to the disclosure is described hereafter based on a method of transforming a LWE ciphertext into a RLWE ciphertext and the execution of the method.

First, a basic transformation action is described with reference to FIG. 6.

FIG. 6 is a view provided to explain an action of merging a homomorphic ciphertext according to one embodiment. The action may be referred to as a “scheme transformation action of a ciphertext” since the action includes a transformation between ciphertext schemes different from each other.

Hereafter, a method of merging a plurality of Learning with Errors (LWE) ciphertexts into one Ring Learning with Errors (RLWE) ciphertext is referred to as a “BaseHERMES” operation. The merge action may be represented as Formula 12 described hereafter.

$${BaseHERMES}_{N} = N \cdot {LWE}_{Q} ( {m}_{i} ) \to 1 \cdot {RLWE}_{Q} ( {m}_{i} + {e}_{i} ) \qquad [ Formula 12 ]$$

Herein, BaseHERME is an operator making a plurality of LWE ciphertexts into one RLWE ciphertext, and N is a dimension of RLWE.

The above-described merge action may also be referred to as “Ring Packing”, and involve transforming (or compressing) LWE ciphertexts having a plurality of small moduli q into one RLWE ciphertext of a low dimension n. An action opposite to the merge action may be referred to as “Unpacking”, and represented as Formula 13 described hereafter.

$${UnPack}_{N} : 1 \cdot {RLWE}_{Q} ( {m}_{i} ) \to N \cdot {LWE}_{Q} ( {m}_{i} ) \qquad [ Formula 13 ]$$

Herein, UnPack is an operator transforming one RLWE ciphertext into a plurality of LWE ciphertexts. Unlike a ring packing action, the unpacking action is relatively simple and causes no additional error.

Transforming LWE ciphertexts into a RLWE ciphertext directly by using ring packing is described above, but when implemented, a Middle LWE (MLWE) ciphertext may be used in an intermediate step. In this case, an action may be divided into two steps, and the two steps are comprised of a first step of generating a MLWE ciphertext, and a second step of transforming the MLWE ciphertext into a RLWE ciphertext. The steps are represented mathematically as follows.

$$N \cdot {LWE}_{{Q}_{Enc}}^{K} \to k \cdot {MLWE}_{{Q}_{Enc} N / k}^{k} \to 1 \cdot {RLWE}_{{Q}_{Enc} , N} \qquad [ Formula 14 ]$$

Herein, LWE is a LWE-method ciphertext, MLWE is a MLWE-method ciphertext, RLWE is a RLWE-method ciphertext, and k is an integer less than N. Additionally, Q is a modulus. N may be the number of LWE-method ciphertexts, a rank of a LWE ciphertext, and a degree of a RLWE ciphertext.

The first operation may involve performing k numbers of parallel operations

$$( i . e . , {ModPack}_{N}^{K , N , k} ) ,$$

while the second operation may be performed based on

$${ModPack}_{N}^{k , k , 1} .$$

A ModPack operator is applied to Formula 14 described above as follows.

$$B a s {eHERMES}_{N}^{k , \{ k \}} = {ModPack}_{N}^{k , k , 1} O ( k \cdot {ModPack}_{N}^{K , N , k} ) \qquad [ Formula 15 ]$$

Herein, BaseHERMES is an operator making LWE ciphertexts into one RLWE ciphertext by using a MLWE ciphertext as a middle ciphertext, ModPack is an operator merging a plurality of ciphertexts, K is a rank of LWE, k is a middle rank, and N is a dimension of RLWE.

Hereafter, the process of merging the two steps is described in detail with reference to FIG. 6.

Referring to FIG. 6, a LWE ciphertext 610 is divided into a plurality of groups, and an individual module packing 620 is performed on each group. In the process, two MLWE ciphertexts may be generated, and based on a grouping method and order, a slot position at which each LWE ciphertext in a RLWE ciphertext is to be disposed may be determined.

For example, in the case where each LWE ciphertext is disposed with respect to a middle point in a MLWE structure, the number of switching keys may be decreased. Accordingly, in the case where the merge step is segmented and performed, the size of an entire key used for a ciphertext may be decreased significantly.

In other words, in the case where the first step is segmented into steps and performed, the size of the key may be decreased greatly.

Referring back to the action of FIG. 6 considering the above description, in the case where one MLWE ciphertext 660 is finally generated based on a repetitive packing action described above (620->630, 650->660), the MLWE ciphertext may be transformed into a RLWE ciphertext finally. Such an action may be referred to as a MLWE extraction action.

Hereafter, a transformation action ensuring higher precision is described.

FIG. 7 is a view provided to explain an action of merging a homomorphic ciphertext according to one embodiment. In the embodiment, a method of merging a plurality of LWE ciphertexts into a RLWE ciphertext efficiently and securing high precision is suggested.

Referring to FIG. 7, the electronic apparatus may extract a most significant bit (MSB) area only from each of a plurality of first homomorphic ciphertexts 710, and then merge a plurality of most significant bit regions 720 to generate a third homomorphic ciphertext 730. At this time, the electronic apparatus may apply a rescaling operation to each of the first homomorphic ciphertexts to extract a most significant bit.

Herein, rescaling may be an operation of reducing an integer coefficient to leave a most significant bit region only in a ciphertext.

$${Rescale}_{{q}_{1}} : N \cdot {LWE}_{{q}_{0} {q}_{1}} ( {m}_{i} ) \to N \cdot {LWE}_{{q}_{0}} ( [ {m}_{i} / {q}_{1} ] + {e}_{1 , i} ) \qquad [ Formula 16 ]$$

Herein, N is the number of LWE ciphertexts, Q is a modulus, and q is a rescaling coefficient.

In the case where a merge operation is performed on rescaled ciphertexts, one RLWE-form homomorphic ciphertext may be generated as shown in Formula 17 of FIG. 7. For example, such a merge operation may use baseHERMES_{N} described above.

$$N \cdot {LWE}_{{q}_{0}} ( [ {m}_{i} / {q}_{1} ] + {e}_{1 , i} ) \to 1 \cdot {RLWE}_{{q}_{0}} ( [ {m}_{i} / {q}_{1} ] + {e}_{1 , i} + {e}_{2 , i} ) \qquad [ Formula 17 ]$$

The merge operation, as described above, may use a method of using a middle homomorphic ciphertext as well as a transformation (or merge) method using ring packing.

Then a merged ciphertext may be transformed into a RLWE ciphertext 730 where a most significant bit region is restored, based on inverse rescaling. At this time, a parameter used for inverse rescaling may have a value inversely proportional to a parameter used at a time of rescaling described above.

$$1 \cdot {RLWE}_{{q}_{0}} ( [ {m}_{i} / {q}_{1} ] + {e}_{1 , i} + {e}_{2 , i} ) \to 1 \cdot {RLWE}_{{q}_{0} {q}_{1}} ( {q}_{1} [ {m}_{i} / {q}_{1} ] + {q}_{1} ( {e}_{1 , i} + {e}_{2 , i} ) ) \qquad [ Formula 18 ]$$

Then a least significant bit (LSB) region may be extracted from each of a plurality of first homomorphic ciphertexts 710, and merged to generate a fourth homomorphic ciphertext 760.

First, the process of extracting a least significant bit (LSB) region 750 is described. The electronic apparatus may unpack a third homomorphic ciphertext 730 to generate a plurality of homomorphic ciphertexts 740.

$$1 \cdot {RLWE}_{{q}_{0} {q}_{1}} ( {q}_{1} [ {m}_{i} / {q}_{1} ] + {q}_{1} ( {e}_{1 , i} + {e}_{2 , i} ) ) \to N \cdot {LWE}_{{q}_{0} {q}_{1}} ( {q}_{1} [ {m}_{i} / {q}_{1} ] + {q}_{1} ( {e}_{1 , i} + {e}_{2 , i} ) ) \qquad [ Formula 19 ]$$

Additionally, the electronic apparatus may subtract an unpacked homomorphic ciphertext 740 from each first homomorphic ciphertext 710 to draw a sixth homomorphic ciphertext 750 corresponding to a second region LSB of each first homomorphic ciphertext 710. Herein, unpacking is a process of dividing a RLWE ciphertext to LWE ciphertexts.

$$N \cdot {LWE}_{{q}_{0} {q}_{1}} ( {m}_{i} - {q}_{1} [ {m}_{i} / {q}_{1} ] - {q}_{1} ( {e}_{1 , i} {e}_{2 , i} ) ) \qquad [ Formula 20 ]$$

Then the electronic apparatus may merge a plurality of sixth homomorphic ciphertexts 750 to generate one RLWE homomorphic ciphertext 760. For example, the electronic apparatus may apply “baseHERMES_{N}” to a result of Formula 20 described above to generate a RLWE homomorphic ciphertext.

$$N \cdot {LWE}_{{q}_{0} {q}_{1}} ( {m}_{i} - {q}_{1} [ {m}_{i} / {q}_{1} ] - {q}_{1} ( {e}_{1 , i} + {e}_{2 , i} ) ) \to 1 \cdot {RLWE}_{{q}_{0} {q}_{1}} ( {m}_{i} - {q}_{1} [ {m}_{i} / {q}_{1} ] - {q}_{1} ( {e}_{1 , i} + {e}_{2 , i} ) + {e}_{3 , i} \text{?} \qquad [ Formula 21 ]$$

$$\text{?} \text{indicates text missing or illegible when filed}$$

As a result, the third homomorphic ciphertext (including a most significant bit) 730 and the fourth homomorphic ciphertext (including a least significant bit) 760 may be deemed as a ciphertext where the information of the plurality of first homomorphic ciphertexts is combined efficiently into each RLWE ciphertext, thereby securing higher bit precision (e.g., twice).

Further, the electronic apparatus may merger the ciphertexts 730, 760 to generate one second homomorphic ciphertext 770 finally.

$$1 \cdot {RLWE}_{{q}_{0} {q}_{1}} ( {q}_{1} [ {m}_{i} / {q}_{1} ] + {q}_{1} ( {e}_{1 , i} + {e}_{2 , i} ) ) - 1 \cdot {RLWE}_{{q}_{0} {q}_{1}} ( {m}_{i} - {q}_{1} [ {m}_{i} / {q}_{1} ] - {q}_{1} ( {e}_{1 , i} + {e}_{2 , i} ) + {e}_{3 , i} ) = 1 \cdot {RLWE}_{{q}_{0} {q}_{1}} ( mi + {e}_{3 , i} ) ) \qquad [ Formula 22 ]$$

Then transformed bootstrapping may be performed on the homomorphic ciphertext. The above action may be represented as Formula 23 described hereafter.

$$1 \cdot {RLWE}_{q , N} \begin{matrix}HalfBTS \\ >\end{matrix} 1 \cdot {RLWE}_{Q ,} \text{?} \qquad [ Formula 23 ]$$

$$\text{?} \text{indicates text missing or illegible when filed}$$

Such bootstrapping is an action of transforming a modulus of the homomorphic ciphertext generated in the above process from q, N into Q, N.

Meanwhile, performing bootstrapping separately after generating the second homomorphic ciphertext is described above, but when implemented, bootstrapping and generating the second homomorphic ciphertext may be performed in one step. Such an action is described hereafter.

The above-described process may be referred to as a process of transforming a MSB and a LSB of input data individually and obtaining RLWE_{q}_{₀}(MSBᵢ),RLWE_{q}_{₀}(LSBᵢ) Herein, MSBᵢ and LSBᵢ denote an msb and an lsb of mᵢ respectively, and satisfy q₁·MSBᵢ+LSBᵢ=mᵢ. More precisely, MSBᵢ may be represented as Formula 24, and LSBᵢ may be represented as Formula 25.

$${MSB}_{i} = [ {m}_{i} / {q}_{1} ] + ( {e}_{1 , i} + {e}_{2 , i} ) \qquad [ Formula 24 ]$$

$${LSB}_{i} = {m}_{i} - {q}_{1} [ {m}_{i} / {q}_{1} ] - {q}_{1} ( {e}_{1 , i} + {e}_{2 , i} ) + {e}_{3 ,} \text{?} \qquad [ Formula 25 ]$$

$$\text{?} \text{indicates text missing or illegible when filed}$$

Like an ordinary rebooting process, the bootstrapping process may involve increasing a modulus, and at the same time, combining two ciphertexts separated into MSBs and LSBs into one RLWE ciphertext. In a process described hereafter, Q is a bootstrapping target modulus higher than q₀, q₁.

First, the electronic apparatus may perform halfBoot processing on a MSB.

$${RLWE}_{{q}_{0}} ( {MSB}_{i} ) \to {RLWE}_{Q} ( {MSB}_{i} + {e}_{1 , i} ) \qquad [ Formula 26 ]$$

Additionally, the electronic apparatus may multiply a result of the above processing by q₁.

$${RLWE}_{Q} ( {MSB}_{i} + {e}_{1 , i} ) \to {RLWE}_{Q} ( {q}_{1} \cdot {MSB}_{i} + {q}_{1} \cdot {e}_{1 , i} \text{?} \qquad [ Formula 27 ]$$

$$\text{?} \text{indicates text missing or illegible when filed}$$

Since an output of Formula 27 is (in) a slot encoding state, and input ciphertexts are (in) a coefficient encoding state, a linear transformation ((slotToCoeff) of transforming a slot into a coefficient may be performed on the output in advance to subtract the two ciphertexts. At this time, since q₁·MSBᵢ+q₁·e_{1,i} needs to be corrected entirely, a high-precision linear transformation may be performed. In other words, the linear transformation may be performed by using a high scale value.

Additionally, the electronic apparatus may multiply RLWE_{q}_{₀}(MSBᵢ) by q1, and then subtract a result of the above linear transformation.

$${RLWE}_{{q}_{0}} ( {q}_{1} \cdot {e}_{1 , i} \text{?} \qquad [ Formula 28 ]$$

$$\text{?} \text{indicates text missing or illegible when filed}$$

Further, the electronic apparatus may add an immediately preceding result to RLWE_{q}_{₀}(LSBᵢ).

$${RLWE}_{{q}_{0}} ( {LSB}_{i} - {q}_{1} \cdot {e}_{1 , i} ) \qquad [ Formula 29 ]$$

Furthermore, the electronic apparatus may perform halfBoot processing again on a result of the above.

$${RLWE}_{{q}_{0}} ( {LSB}_{i} - {q}_{1} \cdot {e}_{1 , i} ) \to {RLWE}_{Q} ( {LSB}_{i} - {q}_{1} \cdot {e}_{1 , i} + {e}_{2 , i} ) \qquad [ Formula 30 ]$$

Outputs of Formula 26 and Formula 30 described above are a RLWE ciphertext of a high modulus that encrypts a MSB and a LSB of input ciphertext data. In other words, the outputs may satisfy Formula 31 described hereafter.

$${q}_{1} \cdot ( {MSB}_{i} + {e}_{1 , i} ) + {LSB}_{i} - {q}_{1} \cdot {}_{1 , i} + {e}_{2 , i} = {m}_{i} + {e}_{2 , i} \qquad [ Formula 31 ]$$

The method suggested in the embodiment may secure a greater decrease in calculation complexity and memory consumption than an existing single merge method. In particular, a method of setting N/n numbers of merge units based on a small ring n is advantageous over single packing using a large-dimension ring N in terms of a ciphertext processing speed and a key size.

A messages transformed based on the method is placed in a coefficient domain, and accordingly, a linear transformation process into a slot domain performed in existing bootstrapping may be advantageously omitted.

Meanwhile, dividing a message into two (a MSB and a LSB) and performing the above processing is described above. However, when implemented, the message may be divided into three or more for processing. Hereafter, dividing the above-described action t times for ring packing is described. An action described hereafter is referred to as META-HERMESₜ, and the META-HERMESₜ may be divided into BaseHermes+META-HERMESₜ₋₁.

First, the electronic apparatus may perform rescaling on one ciphertext described as follows.

$$N \cdot {LWE}_{{q}_{0} {q}_{1} … {q}_{t - 1}} ( {m}_{i} ) \to N \cdot {LWE}_{{q}_{0} … {q}_{t - 2}} ( [ {m}_{i} / {q}_{t - 1} ] + {e}_{1 , t - 1 , i} ) \qquad [ Formula 32 ]$$

Additionally, the electronic apparatus may perform a merge operation, i.e., META-HERMESₜ₋₁ on a result of the rescaling.

$$N \cdot {LWE}_{{q}_{0} … {q}_{t - 2}} ( [ {m}_{i} / {q}_{t - 1} ] + {e}_{1 , t - 1 , i} ) \to 1 \cdot {RLWE}_{{q}_{0} {q}_{1} … {q}_{t - 2}} ( [ {m}_{i} / {q}_{t - 1} ] + {e}_{1 , t - 1 , i} ) \qquad [ Formula 33 ]$$

Based on the above process, the electronic apparatus may obtain t−1 numbers of RLWE ciphertexts divided into MSB-LSB for encryption.

Additionally, the electronic apparatus may perform inverse rescaling on the t−1 numbers of obtained ciphertexts.

$$1 \cdot {RLWE}_{{q}_{0} {q}_{1} … {q}_{t - 2}} ( [ {m}_{i} / {q}_{t - 1} ] + {e}_{1 , t - 1 , i} ) \to 1 \cdot {RLWE}_{{q}_{0} {q}_{1 …} {q}_{t - 1}} ( {q}_{t - 1} [ {m}_{i} / {q}_{t - 1} ] + {q}_{t - 1} ( {e}_{1 , t - 1 , i} + {e}_{2 , t - 1 , i} ) ) \qquad [ Formula 34 ]$$

Based on the above-described inverse rescaling, the electronic apparatus may obtain t−1 numbers of RLWE ciphertexts divided into MSB-LSB for encryption.

Then the electronic apparatus may perform unpacking on the ciphertexts. Additionally, the electronic apparatus may subtract a result of the unpacking from an initial input, for storage. In other words, since in the unpacked ciphertexts, MSB portions of the input ciphertext data are encrypted, ciphertexts left after the subtraction of the MSB portions from the input may be naturally ciphertexts where remaining LSB portions are encrypted excluding the MSB portions from the initial ciphertext data.

$$N \cdot {LWE}_{{q}_{0} … {q}_{t - 1}} ( {m}_{i} - {q}_{t - 1} [ {m}_{i} / {q}_{t - 1} ] + {q}_{t - 1} ( {e}_{1 , t - 1 , i} + {e}_{2 , t - 1 , i} ) ) \qquad [ Formula 35 ]$$

The electronic apparatus may apply “baseHERMESN” to Formula 35.

$$N \cdot {LWE}_{{q}_{0} {q}_{t - 1}} ( {m}_{i} - {q}_{t - 1} [ {m}_{i} / {q}_{1} ] - {q}_{t - 1} ( {e}_{1 , t - 1 , i} + {e}_{2 , t - 1 , i} ) ) \to 1 \cdot {RLWE}_{{q}_{0} {q}_{t - 1}} ( {m}_{i} - {q}_{t - 1} \text{?} {m}_{i} / {q}_{t - 1} \text{?} - {q}_{t - 1} ( {e}_{1 , t - 1 , i} + {e}_{2 , t - 1 , i} ) + {e}_{3 , t - 1 , i} \text{?} \qquad [ Formula 36 ]$$

$$\text{?} \text{indicates text missing or illegible when filed}$$

Results of Formula 33 and Formula 36 described above may be ciphertexts where an input ciphertext is divided for encryption. Then the electronic apparatus may repeat the above process to obtain t numbers of ciphertexts, and merge the ciphertexts to generate one homomorphic ciphertext finally.

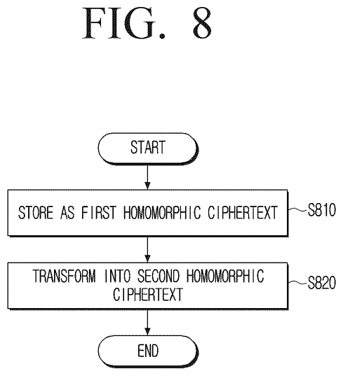

FIG. 8 is a flowchart provided to explain a control method of an electronic apparatus according to one embodiment.

Referring to FIG. 8, an electronic apparatus stores a plurality of first homomorphic ciphertexts homomorphically encrypted based on a first scheme (S810). For example, the first homomorphic ciphertexts may be the ones transmitted from an external device. Accordingly, the electronic apparatus may temporarily store the homomorphic ciphertexts received from the external device in memory, and then in the case where predetermined numbers of the first homomorphic ciphertexts are collected, transform the first homomorphic ciphertexts into second homomorphic ciphertexts described hereafter and store the second homomorphic ciphertexts in the memory.

When implemented, the electronic apparatus may also receive middle-form homomorphic ciphertexts rather than the first homomorphic ciphertexts, and merge the middle-form homomorphic ciphertexts in the form of a second-form homomorphic ciphertext.

The electronic apparatus transforms the plurality of stored first homomorphic ciphertexts into second homomorphic ciphertexts of a second form (S820). For example, in the case where matrix data are stored, storing the matrix data in a bundle is more efficient than storing the matrix data as individual data based on the capacity of a linear term. Accordingly, in the disclosure, a plurality of LWE-method homomorphic ciphertexts may be merged into RLWE-method homomorphic ciphertexts, for storage.

For example, the merge process may include two steps broadly, and a first step is a method by which a plurality of first homomorphic ciphertexts is viewed as homomorphic ciphertexts having a rank of k and a dimension of 1 and transformed into a third homomorphic ciphertext having a plurality of dimensions, and the third homomorphic ciphertext is transformed into a second homomorphic ciphertext having a rank of 1 and a dimension of N. In other words, the first step is a method using a MLWE-form middle ciphertext described above. For example, the plurality of first homomorphic ciphertexts may be transformed into k numbers of third homomorphic ciphertexts having a rank of k and a dimension of N/k by using a packing method, and the k numbers of third homomorphic ciphertexts may be transformed into one second homomorphic ciphertext by using a ring switching method.

Alternatively, the merge process may use the following method without using the middle ciphertext. For example, the plurality of first homomorphic ciphertexts may be transformed into a plurality of third homomorphic ciphertexts having a dimension of No lower than a dimension of N and a rank of 1, and the plurality of third homomorphic ciphertexts may be transformed into a second homomorphic ciphertext having a rank of 1 and a dimension of N.

As the second homomorphic ciphertext is generated as described above, the electronic apparatus may perform bootstrapping on the second homomorphic ciphertext, to change a modulus of the second homomorphic ciphertext. In the disclosure, an existing bootstrapping method or a bootstrapping method specialized for the subject matter of the disclosure may be used.

In other words, in the case of an above-described transformation in the disclosure, all data belong to a coefficient coff, and accordingly, bootstrapping may be performed by expanding a modulus of the second homomorphic ciphertext (ModRaise), approximately operating the second homomorphic ciphertext of which the modulus is expanded by using a function set to approximate a modulated range of a plaintext (EvalMod), and linearly transforming the approximately operated homomorphic ciphertext in a ciphertext form (CoeffToSlot), without performing a linear transformation action of transforming from a slot into a coefficient, performed in existing bootstrapping.

Additionally, the electronic apparatus may store a finally generated homomorphic ciphertext. The control method of the electronic apparatus according to the disclosure stores a plurality of homomorphic ciphertexts as one homomorphic ciphertext for use, and is advantageous in management and storage capacity, as described above.

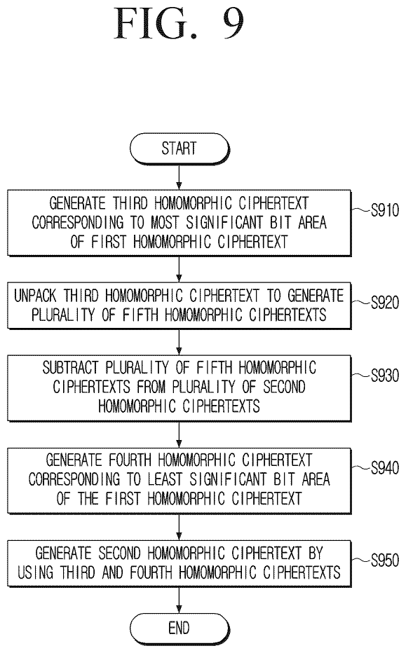

In the case where the above merge process is performed, precision may be affected in the process. To enhance precision, the electronic apparatus may repeat the above-described action. For example, the electronic apparatus may also perform the merge action on a first region (i.e., a most significant bit region) of the plurality of first homomorphic ciphertexts, then perform the merge action on a second region (i.e., a least significant bit (LSB) region) of the plurality of first homomorphic ciphertexts, and merge the ciphertexts corresponding to the most significant bit region and the least significant bit (LSB) area to generate the second homomorphic ciphertext finally. Hereafter, such an action is described in detail with reference to FIG. 9.

FIG. 9 is a flowchart provided to explain a method of merging a plurality of homomorphic ciphertexts into one according to one embodiment.

Referring to FIG. 9, an electronic apparatus first generates one third homomorphic ciphertext corresponding to a first region of each of a plurality of first homomorphic ciphertexts (S910). Herein, the third homomorphic ciphertext is a ciphertext where a most significant bit (MSB) area in each of the plurality of first homomorphic ciphertexts is only merged into one ciphertext. The third homomorphic ciphertext may also be referred to as a MSB RLWE ciphertext.

To perform the above-described action, the electronic apparatus may first extract only a most significant bit region of each of the plurality of first homomorphic ciphertexts. For example, the electronic apparatus may perform rescaling on each of the plurality of first homomorphic ciphertexts.

When obtaining a homomorphic ciphertext corresponding to the most significant bit region of each of the plurality of first homomorphic ciphertexts as described above, the electronic apparatus may merge the rescaled homomorphic ciphertext to generate one RLWE ciphertext. At this time, the electronic apparatus may use a method of transforming a LWE ciphertext directly into RLWE based on a ring packing method, or a method of using a MLWE ciphertext as an intermediate medium.

In the latter case, the electronic apparatus views a rescaled ciphertext as a homomorphic ciphertext having a rank of k and a dimension of 1, and transform the rescaled ciphertext into a seventh homomorphic ciphertext having a plurality of dimensions. Additionally, the electronic apparatus may generate one eighth homomorphic ciphertext having a rank of 1 and a dimension of N by using the seventh homomorphic ciphertext having a plurality of dimensions.

Additionally, the electronic apparatus may inverse-rescale the eighth homomorphic ciphertext to generate a third homomorphic ciphertext. At this time, a parameter used for inverse rescaling may have a value inversely proportional to a parameter used at a time of previous rescaling.

As the third homomorphic ciphertext is generated as described above, an action for generating a fourth homomorphic ciphertext may be performed. Herein, the fourth homomorphic ciphertext is a ciphertext where a least significant bit (LSB) region in each of the plurality of first homomorphic ciphertexts is only merged into one ciphertext. Such a fourth homomorphic ciphertext may be referred to as a LSB RLWE ciphertext.

To this end, the third homomorphic ciphertext generated previously is first unpacked to generate a plurality of fifth homomorphic ciphertexts (S920). At this time, the plurality of generated fifth homomorphic ciphertexts may correspond to a most significant bit region of each of the first homomorphic ciphertexts, but differ from the plurality of first homomorphic ciphertexts in an error value.

Additionally, the electronic apparatus subtracts the plurality of fifth homomorphic ciphertexts from each of the plurality of first homomorphic ciphertexts to generate a plurality of sixth homomorphic ciphertexts corresponding to a second region of each of the plurality of first homomorphic ciphertexts (S930). Since an unpacked fifth homomorphic ciphertext is a ciphertext in which a most significant bit (MSB) area of input ciphertext data is encrypted, a ciphertext left after subtraction of the most significant bit (MSB) area from the input is naturally a ciphertext in which a remaining least significant bit (LSB) area is encrypted excluding the most significant bit (MSB) area in the initial ciphertext data.

When obtaining the plurality of sixth homomorphic ciphertexts as described above, the electronic apparatus may generate one fourth homomorphic ciphertext corresponding to a second region of each of the plurality of first homomorphic ciphertexts (S940). For example, the electronic apparatus, as described above, may perform a merge action by using a ring packing method or by using a method of using a MLWE form in an intermediate step. In the case where the electronic apparatus uses a method described hereafter, the electronic apparatus may view the plurality of sixth homomorphic ciphertexts as a homomorphic ciphertext having a rank of k and a dimension of 1, and transform the plurality of sixth homomorphic ciphertexts into a ninth homomorphic ciphertext having a plurality of dimensions. Additionally, the electronic apparatus may generate one fourth homomorphic ciphertext having a rank of 1 and a dimension of N by using the ninth homomorphic ciphertext.

In this process, the electronic apparatus may transform the plurality of sixth homomorphic ciphertexts into k tenth homomorphic ciphertexts having a rank of k and a dimension of N/k, and merge the k tenth homomorphic ciphertexts into one fourth homomorphic ciphertext. In the disclosure, the above-described merge process is performed twice as described above. That is, the first merge action and the second merge action may be performed in the same way. For example, the first and second actions may both use a ring packing method or a method of generating and using a MLWE-form ciphertext as an intermediate medium.

On the contrary, the first and second merge actions may use a different method.

Finally, the third homomorphic ciphertext and the fourth homomorphic ciphertext generated previously may be used to generate a second homomorphic ciphertext (S950). For example, the two ciphertexts may be merged by performing homomorphic addition. At this time, the merge and bootstrapping processes may be performed at the same time. Description in relation to this is provided above with reference to FIG. 7, and not repeated.

Meanwhile, diving a homomorphic ciphertext into two, i.e., a most significant bit (MSB) area and a least significant bit (LSB) region, for processing is described above, but as described with reference to FIG. 7, a homomorphic ciphertext may be divided into three or more for processing.

Then the electronic apparatus may store a finally generated homomorphic ciphertext. As described above, a plurality of homomorphic ciphertexts is stored as one homomorphic ciphertext for use, thereby ensuring ease of management and storage capacity. Additionally, in a transformation process, the most significant bit region and the least significant bit (LSB) area are divided for processing, thereby securing a finally generated homomorphic ciphertext of precision twice greater than that of a conventional one.

Further, the above-described merge action may be used not only for storing a plurality of ciphertexts but also for transmitting a plurality of homomorphic ciphertexts to the outside, to reduce a transmission amount.

The above-described ciphertext processing method may be stored in a non-transitory readable storage medium. An apparatus equipped with such a non-transitory readable storage medium may perform actions such as generation of a public key, encryption, decryption, vector search and the like that are described in the above embodiments.

In the non-transitory readable storage medium, the term “non-transitory” only means that a storage medium includes no signal and is tangible, while the term does distinguish semi-permanent or temporary storage of data in the storage medium.

Alternatively, a program for performing the methods according to the above-described embodiments may be distributed online through an application store. In the case of online distribution, at least part of a computer program product (e.g., a downloadable app) may be stored at least temporarily, or generated temporarily in a storage medium such as a server of a manufacturer, a server of an application store, or memory of a relay server.

Each of the elements (e.g., a module or a program) according to the embodiments may be comprised of a single entity or multiple entities, and some corresponding sub elements described above may be omitted, or another sub element may be further included in the embodiments. Alternatively or additionally, some of the elements (e.g., modules or programs) may be integrated into one entity to perform functions performed by each of the elements prior to the integration in an identical or similar way. Operations performed by a module, a program, or another element, according to the embodiments, may be executed sequentially, in parallel, repetitively, or heuristically, or at least part of the operations may be executed in a different order, may be omitted, or may add a different operation.

While the example embodiments of the disclosure are illustrated and described above, embodiments of the disclosure are not limited to the embodiments set forth herein, and certainly, various modifications thereof may be made by those skilled in the art to which the disclosure pertains, without departing from the scope of the subject matter of the disclosure claimed in the section of claims, and are not to be understood as separating from the technical spirit or prospect of the disclosure.

1. A ciphertext processing method of an electronic apparatus,
the method comprising:
storing a plurality of first homomorphic ciphertexts homomorphically encrypted according to a first scheme; and
transforming the plurality of stored first homomorphic ciphertexts into a second homomorphic ciphertext according to a second scheme,
wherein the transforming comprises:
generating one third homomorphic ciphertext corresponding to a first region of each of the plurality of first homomorphic ciphertexts;
generating one fourth homomorphic ciphertext corresponding to a second region of each of the plurality of first homomorphic ciphertexts; and
generating the second homomorphic ciphertext by using the third homomorphic ciphertext and the fourth homomorphic ciphertext,
wherein the second region excludes the first region from the entire region.

2. The ciphertext processing method of claim 1, wherein the transforming further comprises:
generating a plurality of fifth homomorphic ciphertexts by unpacking the one third homomorphic ciphertext; and
generating a plurality of sixth homomorphic ciphertexts corresponding to a second region of each of the plurality of first homomorphic ciphertexts by performing subtraction of the plurality of fifth homomorphic ciphertexts from each of the plurality of first homomorphic ciphertexts.

3. The ciphertext processing method of claim 1, wherein the generating of the one third homomorphic ciphertext comprises:
rescaling each of the plurality of first homomorphic ciphertexts to obtain a plurality of first homomorphic ciphertexts corresponding to a most significant bit region;
treating the rescaled plurality of first homomorphic ciphertexts as a homomorphic ciphertext having a rank k and a dimension of 1, and converting the rescaled plurality into a seventh homomorphic ciphertext having a plurality of dimensions;
generating one eighth homomorphic ciphertext having a rank of 1 and a dimension of N by using the seventh homomorphic ciphertext having a plurality of dimensions; and
generating the third homomorphic ciphertext by inverse-rescaling the eighth homomorphic ciphertext.

4. The ciphertext processing method of claim 1, wherein the generating of the one fourth homomorphic ciphertext comprises:
transforming a plurality of sixth homomorphic ciphertexts into a ninth homomorphic ciphertext having a plurality of dimensions by treating the plurality of sixth homomorphic ciphertexts corresponding to a remaining second region of each of the plurality of first homomorphic ciphertexts as a homomorphic ciphertext having a rank k and a dimension of 1; and
generating the one fourth homomorphic ciphertext having a rank of 1 and a dimension of N by using the ninth homomorphic ciphertext.

5. The ciphertext processing method of claim 4, wherein the transforming into the ninth homomorphic ciphertext comprises:
transforming the plurality of sixth homomorphic ciphertexts into k tenth homomorphic ciphertexts having a rank of k and a dimension of N/k,
wherein the transforming into the fourth homomorphic ciphertext comprises: merging the k tenth homomorphic ciphertexts into the one fourth homomorphic ciphertext.

6. The ciphertext processing method of claim 1,
wherein the first region is a most significant bit region of a homomorphic ciphertext, and
the second region is a least significant bit (LSB) region excluding the most significant bit region from an entire region.

7. The ciphertext processing method of claim 1, further comprising:
receiving the plurality of first homomorphic ciphertexts; and
storing the second homomorphic ciphertext.

8. An electronic apparatus comprising;
memory configured to store at least one instruction; and
a processor configured to execute the at least one instruction, to transform a plurality of first homomorphic ciphertexts homomorphically encrypted according to a first scheme into a second homomorphic ciphertext according to a second scheme,
the processor configured to:
generate one third homomorphic ciphertext corresponding to a first region of each of the plurality of first homomorphic ciphertexts;
generate one fourth homomorphic ciphertext corresponding to a second region of each of the plurality of first homomorphic ciphertexts; and
generate the second homomorphic ciphertext by using the third homomorphic ciphertext and the fourth homomorphic ciphertext,
wherein the second region excludes the first region from the entire region.

9. The electronic apparatus of claim 8, wherein the processor is configured to:
generate a plurality of fifth homomorphic ciphertexts by unpacking the one third homomorphic ciphertext, and
generate a plurality of sixth homomorphic ciphertexts corresponding to a second region of each of the plurality of first homomorphic ciphertexts by performing subtraction of the plurality of fifth homomorphic ciphertexts from each of the plurality of first homomorphic ciphertexts.

10. The electronic apparatus of claim 8, wherein the processor is configured to:
rescale each of the plurality of first homomorphic ciphertexts to obtain a plurality of first homomorphic ciphertexts corresponding to a most significant bit region;
treat the rescaled plurality of the first homomorphic ciphertexts as a homomorphic ciphertext having a rank of k and a dimension of 1, and convert the rescaled plurality of the first homomorphic ciphertexts into a seventh homomorphic ciphertext having a plurality of dimensions;
generate one eighth homomorphic ciphertext having a rank of 1 and a dimension of N by using the seventh homomorphic ciphertext having a plurality of dimensions; and
generate the third homomorphic ciphertext by inverse-rescaling the eighth homomorphic ciphertext.

11. The electronic apparatus of claim 8, wherein the processor is configured to:
transform a plurality of sixth homomorphic ciphertexts into a ninth homomorphic ciphertext having a plurality of dimensions by treating the plurality of sixth homomorphic ciphertexts corresponding to a remaining second region of each of the plurality of first homomorphic ciphertexts as a homomorphic ciphertext having a rank k and a dimension of 1; and
generate the one fourth homomorphic ciphertext having a rank of 1 and a dimension of N by using the ninth homomorphic ciphertext.

12. The electronic apparatus of claim 11, wherein the processor is configured to
transform the plurality of sixth homomorphic ciphertexts into k tenth homomorphic ciphertexts having a rank of k and a dimension of N/k,
merge the k tenth homomorphic ciphertexts into the one fourth homomorphic ciphertext.

13. The electronic apparatus of claim 8,
wherein the first region is a most significant bit region of a homomorphic ciphertext, and
the second region is a least significant bit (LSB) region excluding the most significant bit region from an entire region.

14. The electronic apparatus of claim 8, further comprising:
a communication device configured to communicate with an external device,
wherein, when the processor receives the plurality of first homomorphic ciphertexts through the communication device, the processor stores the second homomorphic ciphertext corresponding to the plurality of first homomorphic ciphertexts in the memory.

15. A non-transitory computer-readable recording medium including a program for executing a ciphertext processing method,
the method comprising:
storing a plurality of first homomorphic ciphertexts homomorphically encrypted according to a first scheme; and
transforming the plurality of stored first homomorphic ciphertexts into a second homomorphic ciphertext according to a second scheme,
wherein the transforming comprises:
generating one third homomorphic ciphertext corresponding to a first region of each of the plurality of first homomorphic ciphertexts;
generating one fourth homomorphic ciphertext corresponding to a second region of each of the plurality of first homomorphic ciphertexts; and
generating the second homomorphic ciphertext by using the third homomorphic ciphertext and the fourth homomorphic ciphertext,
wherein the second region excludes the first region from the entire region.
